(19) United States
(12) Patent Application Publication
(10) Pub. No.: US 2007/0108386 A1
(43) Pub. Date: May 17, 2007

(54) Sheet which can be authenticated by means of near infrared spectroscopy and authentication method

(75) Inventors: Johannes Krul, Beuningen (NL); Pierre Doublet, Saint-Brice (FR); Pierre Caulet, Paladru (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ARJOWIGGINS SECURITY, ISSY LES MOULINEAUX (FR)

(21) Appl. No.: 10/573,645

(22) PCT Filed: Sep. 29, 2004
(86) PCT No.: PCT/FR04/02460

§ 371 Date: Mar. 28, 2006

(30) Foreign Application Priority Data
Sep. 29, 2003 (FR) 03/11383

(51) Int. Cl. G01N 21/35

(52) U.S. Cl. 250/339.1; 428/195.1

(57) ABSTRACT

The invention relates to a sheet identifiable by near infrared spectroscopy, which includes at least one NIR component sensitive to radiation in the near infrared, and qualifiable and/or quantifiable by near infrared spectroscopy using a specific calibration. It also relates to the method of authenticating this sheet.

The invention relates to a sheet that can be authenticated by near infrared spectroscopy and to the method of authenticating said sheet.

To combat the counterfeiting of security documents, such as means of payment and identity documents, security elements have been introduced into and/or on these documents, these elements being now well known and giving the documents authenticating characteristics. These characteristics are often associated with particular physical, chemical or biological properties, which can be revealed by a suitable detection system. These security elements are for example pigments, fibers, strips, security threads, foils or patches applied by transfer, surface varnish or printing, films affixable to the document. These elements have, intrinsically or via the materials that are introduced into the bulk and/or surface thereof, particular properties such as magnetic, electrical, electromagnetic-wave absorption or luminescence (UV, visible or infrared fluorescence or phosphorescence) properties, microwave or radiofrequency resonance properties, biological properties, especially DNA-based properties, or properties deriving from chemicals or from chemical reactions.

Usually documents of value include a watermarked region that allows them to be authenticated. Conventional watermarks in papers are produced on embossed wires used for depositing the constituent fibers of the paper in variable quantities depending on whether the embossing is formed by hollows or bumps. Those regions of the paper having more fibers appear dark, whereas those having fewer of them appear light when the paper is observed in transmitted light. Novel watermarks made using a pattern of masks having fewer variations in thickness on one face of the sheet have been described in patent EP 1 122 360.

Watermarks may represent a barcode, which serves as additional means of authenticating the document.

However, counterfeiters can imitate with greater or lesser success the visual appearance of conventional watermarks by applying transparentizing ink or opacifying grey ink, or else by collages on the paper.

Various methods for improving the authentication of watermarks by radiation have already been proposed. For example, in the patent EP 381 550, the watermark is identified by recognition of its X-ray image. In patent EP 1 276 079, the watermark is identified by infrared spectroscopy, by analyzing the light areas of reduced surface density and the dark areas of higher surface density, in transmission through the document, the response being dependent on the mass traversed.

It therefore proves necessary to solve the abovementioned drawbacks and to increase the security of documents and that of the method of authenticating them.

Patent application WO 0228954 describes a product that is a polymer, a textile or a paper and that includes what is called an “NIR marker”, which compound has a strong absorption band in the near infrared (the most often named according to its English symbol “NIR” standing for Near Infra Red) so that it can be spectroscopically recognized in the NIR absorption spectrum of the product. The marker may be a mineral filler chosen from kaolin, talc, basic magnesium carbonates or mixtures thereof. The above patent also describes the associated method of authentication, especially for banknotes. This characterization simply relies on the presence or absence of the NIR marker.

To solve the abovementioned drawbacks and further enhance the means for combating falsification, the Applicant proposes a sheet that has particular characteristics that can be identified in the near infrared but impossible to find without knowing in advance the data to look for.

Near infrared radiation lies between 4000 and 12 000 cm⁻¹, i.e. between 800 and 2500 nm. Near infrared radiation is absorbed by the chemical bonds of compounds that are due to harmonic vibrations and combination vibrations. This allows the presence of one or more compounds to be determined at one or more typical wavelengths. Analysis of the near infrared radiation absorbed by the sheet to be characterized can be carried out by transmission through the specimen in relation to its bulk data, or by reflection, especially by diffuse reflection, in relation to its surface data, or else by simultaneous transmission and reflection analysis, called transreflection analysis. It allows particular quantitative or qualitative characterizations to be made despite the complexity of the spectra—since the characteristic peaks are masked by other, interfering peaks, a suitable calibration of the spectrophotometer must be carried out. Chemiometric methods are applied in order to refine the calibration. The calibration therefore relies on sophisticated procedures requiring the most appropriate chemiometric processing of the spectral data acquired to be chosen according to the nature of the product analyzed and of the NIR-sensitive component. The chemiometric techniques used are very often principal component analysis (PCA), principal component regression (PCR) and partial least squares (PLS). Preferably, the chemiometric processing is directly integrated into the spectrum acquisition software. The calibration is difficult to implement and requires specific work using specimens that are properly referenced with variable well-defined quantities of the sensitive component, and the measurements being carried out at well-chosen wavelengths. The calibration may be based on the entire spectrum instead of being based on one or more given wavelengths, using multivariable statistics. Fourier transform near infrared (FT-NIR) spectroscopy has the advantage of measurements being taken at all the frequencies simultaneously.

The invention therefore provides a sheet identifiable by near infrared spectroscopy, which includes at least one NIR component sensitive to radiation in the near infrared, and qualifiable and/or quantifiable by near infrared spectroscopy using a specific calibration. The expression “qualifiable using a specific calibration” is understood to mean that the NIR component is for example identified by its ratio to another component, possibly also sensitive to the near infrared, or by its distribution in the sheet, but without its particular quantity in the sheet having been determined.

In a preferred embodiment of the invention, the sheet includes said NIR component in one or more predetermined quantities, said NIR component being a marker having specific absorption properties in the near infrared.

Preferably, the sheet includes at least two different NIR components sensitive to radiation in the near infrared, said components being present in respective amounts and in a ratio such that their respective spectroscopic properties in the near infrared are concealed within the spectrum of said sheet obtained by spectroscopy in the near infrared, said components being qualifiable and/or quantifiable using said calibration, especially by their respective quantities and/or ratio and/or respective or relative distributions.

According to one particular embodiment of the invention, said NIR components, i.e. those sensitive to near infrared radiation, are chosen from the usual pigment fillers used in cellulose or synthetic paper, preferably from silica oxides, in particular talc or kaolin, from carbonates or blends thereof. Particularly, said components are kaolin and talc as a blend. Other, more specific components may be chosen, especially from synthetic organic polymers.

The sheet according to the invention is a fibrous sheet based on cotton and/or cellulose and/or synthetic fibers, especially a sheet of paper obtained by wet processing and in particular on a cylinder mold paper machine.

The sheet according to the invention may also be a nonfibrous sheet or plastic film, particularly based on one or more polyolefins, especially such as the polypropylene-based sheets sold by Priplak or the polyethylene-based films coated with a pigmented printing-writing layer that are sold by Arjobex.

Preferably, the sheet according to the invention is characterized in that at least one of said NIR components is at least partly integrated into said sheet, in particular said component is integrated within the thickness with the base compounds of said sheet. In one particular embodiment, said NIR component is fixed by chemical bonding to a base compound of said sheet. In particular, said NIR component is fixed by chemical (covalent) bonding to cotton fibers.

In another particular embodiment, at least one of said NIR components is placed in and/or on a so-called security element, such as a thread, a strip or a fiber, and said element is at least partly integrated into the sheet.

The invention is particularly advantageous in the case of sheets that include at least one “variable distribution region” within which at least one NIR component sensitive to near infrared, especially one having a specific absorption in the near infrared, is distributed in a variable manner, the characterization by NIR spectroscopy therefore taking place in this region. Said variable distribution region is a region having, within the thickness, local variations in the distribution of the NIR component(s), which may be a region of variable thickness and/or a region of variable surface density (weight per unit area) and/or a region of variable bulk density.

Preferably, said variable distribution region is a watermarked region or a region associated with the nonuniformity of formation of the sheet.

During manufacture of a sheet, especially a fibrous sheet such as a sheet of paper, the distribution of the ingredients of which it is composed is not perfectly uniform. Consequently, the sheet obtained has, within the thickness, irregularities in the distribution of its ingredients. In the case of a sheet of paper, when this is observed in transmitted light, with the naked eye or with an optical device in the visible, it has a more or less cloudy appearance corresponding to its look-through. Although in general it is desired to have a look-through as even as possible, and in general a sheet whose composition through the thickness is as uniform as possible, there always remains a certain inhomogeneity that may advantageously constitute the signature of the sheet that can be exploited in order to authenticate it. In the present case of the invention, the near infrared spectroscopic analysis, especially in transmission through the sheet, provides a signal that depends on the distribution of the NIR component(s) traversed and therefore gives a spectroscopic response relating to the sheet's signature.

Preferably, said variable distribution region is in the form of a code. In particular, said code is in the form of a pattern with an alternation of regions of reduced thickness and regions of thickness greater than or equal to the thickness of the rest of the sheet, especially a watermark barcode.

The invention also relates to a security document made from a sheet as described above, in particular a banknote.

The invention also relates to a method of authenticating a sheet as described above that includes at least one NIR component sensitive in the near infrared, preferably at least two NIR components, in which method:
at least one region of said sheet that includes said NIR component(s) is exposed to radiation emitted in the near infrared;
the spectral data thus acquired is recorded;
said NIR component(s) is qualified and/or quantified by analyzing the near infrared spectrum thus obtained using a specific calibration held secret and rigorously preestablished on the basis of measurements carried out for sheets that include said NIR component or, as the case may be, various mixtures of said NIR components, which are fully defined by their quantities and ratios;
the data resulting from the spectroscopic analysis thus determined is compared with the original data stored in a database; and
the authenticity of said sheet is validated if the data resulting from the analysis is equal to the original data.

Preferably, the measurements are acquired and analyzed by Fourier transform infrared spectroscopy.

The NIR spectral data is acquired by transmission, by reflection or by transreflection.

Preferably, the authentication method is used for a sheet having a variable distribution region as described above, said region exposed to the near infrared radiation being this said region.

In one particularly advantageous case regarding these variable distribution regions, the NIR spectral data is acquired and analyzed by transmission or by transreflection.

In one particular case, the method according to the invention is such that the spectroscopic image in the near infrared of said variable distribution region is reconstructed using suitable software from the data resulting from the spectroscopic analysis and this image is compared with the original image of said region stored in a database so as to validate the authenticity of the sheet.

In a preferred particular case of the authentication method according to the invention, said variable distribution region is a watermarked region, in particular a watermarked barcode.

In another particular case of the authentication method according to the invention, said variable distribution region is a region associated with the nonuniformity of formation of the sheet, said region being identified with or corresponding to the entire sheet.

In addition, said watermarked region may also be analyzed by mid-infrared spectroscopy in transmission through said watermark.

This method is applied to the authentication of security documents comprising said sheet.

This method of authentication is aimed more particularly at sheets or documents that include a watermarked region, which region has at least one NIR marker having a very specific absorption in the near infrared. This marker has a variable mass distribution owing to the fact that the watermark is made from regions of variable thickness—the dark regions are denser than the light regions, thus giving a response acquired by transmission depends on the mass in this region and therefore being characteristic of the sheet or document.

More generally, this sheet and this method can be applied not only to the authentication of security documents or documents of value (banknotes, checks, etc.) but also to sheets for works of art, such as sheets of drawings, sheets for water colors, to the recognition of sheets used for example as labels or for packaging, in particular for packing a perfume or a medicament; it can also be applied for authenticating a support intended for a particular usage requiring specific cleanliness and sterility characteristics such as sheets used in the medical field for packaging surgical instruments (syringes, scissors, etc.) or else in the hospital field for producing, for example, surgical drapes, etc. The method of authentication therefore applies more generally to articles that have to be authenticated, such as works of art or that have to be security-protected, especially to articles that include a sheet according to the invention with an authentication watermark.

1. A sheet identifiable by near infrared spectroscopy, which includes at least one NIR component sensitive to radiation in the near infrared, and qualifiable and/or quantifiable by near infrared spectroscopy using a specific calibration.

2. The sheet as claimed in the preceding claim, wherein it includes said NIR component in one or more predetermined quantities, said NIR component being a marker having specific absorption properties in the near infrared.

3. The sheet as claimed claim 2, wherein it includes at least two different NIR components sensitive to radiation in the near infrared, said components being present in respective amounts and in a ratio such that their respective spectroscopic properties in the near infrared are concealed within the spectrum of said sheet obtained by spectroscopy in the near infrared, said components being qualifiable and/or quantifiable using said calibration, especially by their respective quantities and/or ratio and/or respective or relative distributions.

4. The sheet as claimed in claim 1, wherein said NIR components are chosen from the usual pigment fillers used in cellulose or synthetic paper, preferably from silica oxides, in particular talc or kaolin, from carbonates and from synthetic organic polymers or blends thereof.

5. The sheet as claimed in claim 1, wherein the sheet is a fibrous sheet based on cotton and/or cellulose and/or synthetic fibers.

6. The sheet as claimed in claim 1, wherein said sheet is a sheet of paper.

7. The sheet as claimed in claim 1, wherein the sheet is a nonfibrous sheet or plastic film, particularly based on one or more polyolefins.

8. The sheet as claimed in claim 1, wherein at least one of said NIR components is at least partly integrated into said sheet.

9. The sheet as claimed in claim 1, wherein said NIR component is integrated within the thickness with the base compounds of said sheet.

10. The sheet as claimed in claim 1, wherein said NIR component is fixed by chemical bonding to a base compound of said sheet.

11. The sheet as claimed in claim 1, wherein at least one of said NIR components is placed in and/or on a so-called security element, such as a thread, a strip or a fiber, and said element is at least partly integrated into the sheet.

12. The sheet as claimed in claim 5 wherein that said NIR component is fixed by chemical bonding to one or more cotton fibers.

13. The sheet as claimed in claim 1, wherein the sheet includes a “variable distribution” region within which at least one NIR component sensitive to near infrared is distributed in a variable manner.

14. The sheet as claimed in claim 13, wherein said region is a watermarked region or a region associated with the nonuniformity of formation of the sheet.

15. The sheet as claimed in claim 13, wherein said variable distribution region is in the form of a code.

16. The sheet as claimed in claim 15, wherein said code is in the form of a pattern with an alternation of regions of reduced thickness and regions of thickness greater than or equal to the thickness of the rest of the sheet, especially a watermarked barcode.

17. A security document, wherein it comprises a sheet as claimed in claim 1.

18. The document as claimed in claim 1, wherein it is a banknote.

19. A method of authenticating a sheet as described in claim 1 that includes at least one NIR component sensitive in the near infrared, preferably at least two NIR components, in which method:
at least one region of said sheet that includes said NIR component(s) is exposed to radiation emitted in the near infrared;
the spectral data thus acquired is recorded;
said NIR component(s) is qualified and/or quantified by analyzing the near infrared spectrum thus obtained using a specific calibration held secret and rigorously preestablished on the basis of measurements carried out for sheets that include said NIR component or, as the case may be, various mixtures of said NIR components, which are fully defined by their quantities and/or ratios;
the data resulting from the spectroscopic analysis thus determined is compared with the original data stored in a database; and
the authenticity of said sheet is validated if the data resulting from the analysis is equal to the original data.

20. The authentication method as claimed in claim 19, wherein the spectral data is acquired and analyzed by Fourier transform near infrared spectroscopy.

21. The authentication method as claimed in claim 19 and for a sheet that includes a variable distribution region within which at least one NIR component sensitive to near infrared is distributed in a variable manner, said region exposed to the near infrared radiation being this region.

22. The authentication method as claimed in claim 21, wherein the spectral data from said variable distribution region is acquired by transmission or by transreflection.

23. The method as claimed in claim 21, wherein the spectroscopic image in the near infrared of said variable distribution region is reconstructed using suitable software from the data resulting from the spectroscopic analysis and this image is compared with the original image of said region stored in a database so as to validate the authenticity of the sheet.

24. The method as claimed in claim 21 wherein said variable distribution region of the sheet is a watermarked region, in particular a watermark in the form of a barcode.

25. The method as claimed in claim 21, wherein said variable distribution region is a region associated with the nonuniformity of formation of the sheet, said region being identified with or corresponding to the entire sheet.

26. The authentication method as claimed in claim 19, applied to the authentication of a security document comprising a sheet identifiable by near infrared spectroscopy, which includes at least one NIR component sensitive to radiation in the near infrared. and qualifiable and/or quantifiable by near infrared spectroscopy using a specific calibration.
